(19) United States
(12) Patent Application Publication
(10) Pub. No.: US 2025/0360727 A1
(43) Pub. Date: Nov. 27, 2025

(54) PRINTING DEVICE AND METHOD FOR CONTROLLING PRINTING DEVICE

(71) Applicant: SEIKO EPSON CORPORATION, Tokyo (JP)

(72) Inventor: Atsushi IMAMURA, SHIOJIRI-SHI (JP)

(21) Appl. No.: 19/216,064

(22) Filed: May 22, 2025

(30) Foreign Application Priority Data
May 23, 2024 (JP) 2024-083902

(51) Int. Cl. B41J 11/00; B41J 15/04; B41J 15/16

(52) U.S. Cl. CPC B41J 11/0022; B41J 11/0024; B41J 15/04; B41J 15/16

(57) ABSTRACT

Printing device 1 including control section 100 includes, when the print medium S is transported after a stop time during which the transport of the print medium S is stopped is equal to or longer than the predetermined time, transports the print medium S at a first acceleration V1, when the print medium S is transported before the stop time exceeds the predetermined time, transports the print medium S at a second acceleration V2 greater than the first acceleration V1.

The present application is based on, and claims priority from JP Application Serial Number 2024-083902, filed May 23, 2024, the disclosure of which is hereby incorporated by reference herein in its entirety.

### BACKGROUND

### 1. Technical Field

The present disclosure relates to a printing device and a method for controlling the printing device.

### 2. Related Art

Conventionally, a printing device including a mechanism for drying an image printed on a print surface of a medium is known. For example, JP2023-133808 discloses a printing device including, inside a drying oven, a rear heater that heats the print medium by contacting the back surface of the print medium, and a blower that blows hot air to the surface of the print medium and that is disposed opposite to the rear heater. However, when the medium remains in the drying oven for a predetermined time or more, sticking occurs between the medium and the back heater, and due to sticking, a transport load of the medium increases, and a transport failure may occur.

### SUMMARY

The present disclosure includes a printing device including a transport section configured to perform intermittent transport in which an operation of transporting a medium in a transport direction by a predetermined distance and an operation of stopping the transport of the medium are repeated, a printing section configured to eject a liquid onto the medium to perform printing while the transport of the medium is stopped during the intermittent transport of the medium, a drying section configured to dry the liquid that was ejected onto the medium by the printing section; and a control section, wherein the drying section includes a contact heating section and an airflow ejection section that is disposed at a position facing the contact heating section and that is configured to eject an airflow from an airflow ejection port, the contact heating section includes a contact heating surface that contacts a back surface opposite from a print surface, which is the surface of the medium onto which the printing section ejects the liquid, the airflow ejection port faces the contact heating surface, the control section is configured to transport the medium at a first acceleration when the medium is transported after a stop time during which transport of the medium by the transport section is stopped is equal to or longer than a predetermined time and transport the medium at a second acceleration greater than the first acceleration when the medium is transported before the stop time exceeds the predetermined time, and the stop time of the medium in the intermittent transport is less than the predetermined time.

The present disclosure includes a control method of a printing device, the printing device including a transport section configured to perform intermittent transport in which an operation of transporting a medium in a transport direction by a predetermined distance and an operation of stopping the transport of the medium are repeated, a printing section configured to eject a liquid onto the medium to perform printing while the transport of the medium is stopped during the intermittent transport of the medium, and a drying section that dries the liquid that was ejected onto the medium by the printing section, wherein the drying section includes a contact heating section and an airflow ejection section that is disposed at a position facing the contact heating section and that ejects an airflow from an airflow ejection port, the contact heating section includes a contact heating surface that contacts a back surface opposite to a print surface of the medium onto which the printing section ejects the liquid, and the airflow ejection port faces the contact heating surface, the control method including transporting the medium at a first acceleration when the medium is transported after a stop time during which the transport of the medium by the transport section is stopped is equal to or longer than a predetermined time and when the medium is transported before the stop time exceeds the predetermined time, transporting at a second acceleration that is greater than the first acceleration, wherein the stop time of the medium in the intermittent transport is less than the predetermined time.

### BRIEF DESCRIPTION OF THE DRAWINGS

FIG. 1 is a diagram showing a configuration of a printing device.

FIG. 2 is a diagram showing a configuration of the drying section.

FIG. 3 is a perspective view of the periphery of the drying section of the printing device, as viewed from the rear side.

FIG. 4 is a cross-sectional view of the periphery of the drying section of the printing device, as viewed from the rear side.

FIG. 5 is a block diagram showing a control system of a printing device.

FIG. 6 is a diagram showing one frame of print medium.

FIG. 7 is a diagram showing respective values of a plurality of control items controlled by the control section.

FIG. 8 is a timing chart showing the operation of the printing device.

FIG. 9 is a flowchart showing the operation of the printing device.

FIG. 10 is a diagram showing each value of a plurality of control items controlled by the control section of the first modification.

FIG. 11 is a diagram showing a change in the first acceleration of the second modification example.

### DESCRIPTION OF EMBODIMENTS

### 1. Overall Configuration of Printing Device According to First Embodiment

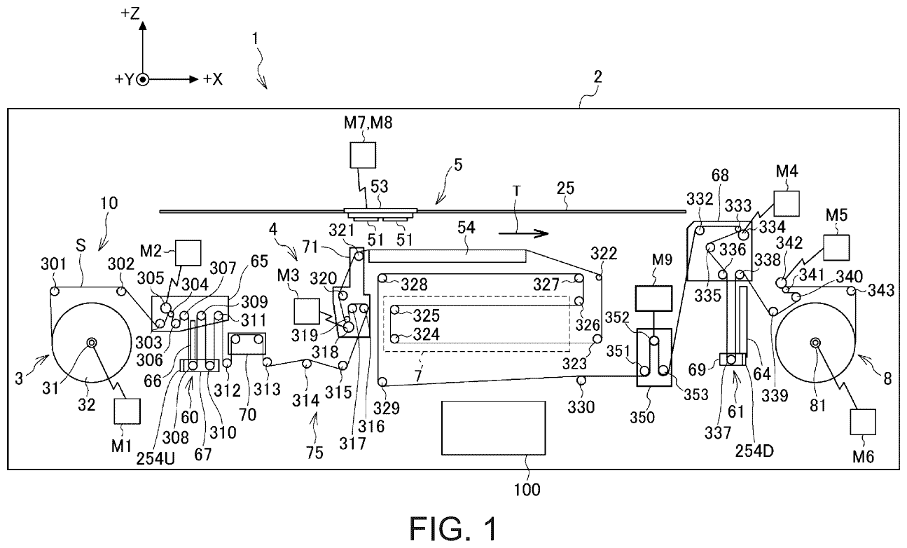

Hereinafter, embodiments of the present disclosure will be described with reference to the drawings. FIG. 1 is a schematic diagram illustrating a schematic configuration of printing device 1 of the first embodiment. In FIG. 1 and each of the drawings described below, XYZ orthogonal coordinates are illustrated in order to describe directions in an installation state of the printing device 1. The Z-axis represents the vertical direction in the installation state of the printing device 1, and can be referred to as the height direction. The vertical upward direction is defined as a +Z direction, and the vertical downward direction is defined as a −Z direction. The X-axis indicates the left-right direction of printing device 1. The right direction in the drawing view is defined as the +X direction, and the left direction in the drawing view is defined as the −X direction. The Y axis is a direction orthogonal to the X axis, and can be referred to as a front-rear direction. A direction from the back side to the front side in the drawing view is defined as a +Y direction, and a direction from the front side to the back side in the drawing view is defined as a −Y direction.

The printing device 1 performs printing on the print medium S by the printing section 5. Various sheets can be used as the print medium S in the printing device 1. In the following description, as the print medium S, a configuration is shown in which a label sheet is used in which labels that have an adhesive on the back side are arranged on a release paper and wound in a roll shape. The printing method of the printing device 1 is not limited, but in the embodiment, an inkjet type printer that ejects ink onto the print medium S by the printing section 5 is shown as an example of the printing device 1.

The printing device 1 has a configuration in which a medium supply section 3, a printing section 5, a drying section 7, a medium collection section 8, and a control section 100 are disposed in a housing 2. The housing 2 is attached to a frame (not shown) of the printing device 1 and accommodates the above-mentioned components.

The print medium S is transported along a transport path 10 between the medium supply section 3 and the medium collection section 8. On the transport path 10, a plurality of transport rollers 301 to 343 abutting on print medium S are disposed. In the transport path 10, the print medium S supplied from the medium supply section 3 is transported in the transport direction T, which is indicated by an arrow in the figure. In the transport path 10, transport rollers 301 to 321 are positioned upstream of the printing section 5. On the other hand, transport rollers 322 to 343 are positioned downstream of the printing section 5.

The printing device 1 includes motors M1 to M6, and these motors M1 to M6 generate a driving force for transporting the print medium S. The motors M1 to M6 correspond to an example of a transport section. A feed-out motor M1, which is the motor M1, drives a supply shaft section 31 of the medium supply section 3, a feed-out nip motor M2, which is the motor M2, drives the transport roller 305, and a supply nip motor M3, which is the motor M3, drives the transport roller 318. The motors M1, M2, and M3 are supply-side power that supplies the print medium S from the medium supply section 3 to the printing section 5. On the other hand, a discharge nip motor M4, which is the motor M4, drives the transport roller 334, a winding nip motor M5, which is the motor M5, drives transport roller 342, and a winding motor M6, which is the motor M6, drives the winding shaft 81 of the medium collection section 8. These motors M4, M5, and M6 are the power on the collection side that collects the post-printing print medium S in the printing section 5 to the medium collection section 8.

The medium supply section 3 includes a cylindrical or columnar supply shaft section 31. A roll body 32, in which the print medium S is wound in a roll shape, can be mounted on the supply shaft section 31, and the medium supply section 3 supports the roll body 32 by the supply shaft section 31. The supply shaft section 31 feeds the print medium S from the roll body 32 toward the printing section 5 by being rotated by the power of the feed-out motor M1.

The printing section 5 prints an image on the print medium S transported on the platen 54 while the transportation of the print medium S is stopped. The printing section 5 prints characters or images on a label of the print medium S by ejecting ink toward the print medium S. These characters and images are collectively called images. The printing section 5 includes a platen 54, a plurality of ejection heads 51 that eject ink, and a carriage 53 that holds the ejection heads 51. An image is formed on the print surface of the print medium S by the ink ejected onto the print medium S by the ejection head 51. The platen 54 has a rectangular surface disposed to be parallel to the XY plane. The platen 54 is, for example, a rectangular flat surface, and is parallel to the XY plane in the installation state of the printing device 1. The platen 54 supports the print medium S from below. The suction hole or the like may be formed in the platen 54 to hold the print medium S on the platen 54 by applying a suction force to the print medium S. The platen 54 corresponds to an example of a support section.

A carriage 53 is disposed above the platen 54 so as to face the platen 54. The carriage 53 is capable of reciprocating in the X-axis direction, which is the main scanning direction, along the first guide rail 25 installed in the printing device 1 along the X-axis direction. The carriage 53 is capable of reciprocating in the Y-axis direction, which is the sub-scanning direction, along the second guide rail (not shown) installed along the Y-axis direction. The printing device 1 includes a first carriage motor M7 that moves the carriage 53 along the first guide rail 25, and a second carriage motor M8 that moves the carriage 53 along the second guide rail. The printing device 1 moves the ejection head 51 in the X-axis direction and the Y-axis direction by the power of the motor M7 and the motor M8. With this configuration, the ejection head 51 can move in the X-axis direction and the Y-axis direction on the print medium S supported by the platen 54 and eject ink onto the entire print medium S.

When printing is performed on the print medium S, the printing device 1 performs intermittent transport of the print medium S. That is, the printing device 1 transports the print medium S to the platen 54, and stops transportation of the print medium S in a state in which the print medium S is disposed in a predetermined area of the platen 54. Here, the printing section 5 ejects ink while moving the ejection head 51 in the X-axis direction and the Y-axis direction, and executes printing on the print medium S. After printing, the printing device 1 transports the print medium S until the printed portion of the print medium S moves downstream of the platen 54 in the transport direction T. Then, the printing device 1 stops the transportation of the print medium S and performs printing by the printing section 5.

In the transport path 10, a feed-out side buffer section 60 and a meandering correction section 70 for correcting the meandering of the print medium S are disposed between the medium supply section 3 and the printing section 5. The configuration of the feed-out side buffer section 60 will be described later.

The meandering correction section 70 includes transport roller 312 and transport roller 313, and corrects meandering of the print medium S between the transport roller 312 and the transport roller 313.

The meandering of the print medium S is a phenomenon in which the transport direction T of the print medium S is inclined in a direction along the Y axis from the transport path 10. The ideal transport state is, for example, a state in which the print medium S is transported from the medium supply section 3 to the platen 54 without moving in the direction along the Y axis. In this state, the print medium S fed from the medium supply section 3 moves along the X axis without moving in the direction along the Y axis, and reaches the platen 54. However, the print medium S may be inclined with respect to the X-axis due to the influence of the inclination or the like of the transport rollers 303 to 311. This inclined state is called meandering. The meandering correction section 70 corrects this when the moving direction of the print medium S is inclined with respect to the X-axis. The print medium S transported from the meandering correction section 70 toward the platen 54 is in a state in which meandering is substantially eliminated.

A meandering accuracy maintenance region 75 for maintaining the meandering accuracy of the print medium S is provided between the meandering correction section 70 and the platen 54. Meandering accuracy indicates the degree of meandering of the print medium S, that is, movement in a direction intersecting the X axis, and may also be referred to as transport accuracy. The transport rollers 313, 314, 315, 316, 317, 318, 319, 320, and 321 are disposed in the meandering accuracy maintenance region 75.

The transport rollers 313, 314 are attached directly or indirectly to the frame of the printing device 1. The transport rollers 313 and 314 are rotatably supported. The vertical plate 71, directly or indirectly fixed to the frame of the printing device 1, is disposed in the meandering accuracy maintenance region 75. The transport roller 315 is rotatably supported on the lower end portion of the vertical plate 71. The six transport rollers 316, 317, 318, 319, 320, and 321 are disposed at the center portion and the upper portion of the vertical plate 71. Each of the transport rollers 316 to 321 is rotatably supported on the vertical plate 71. In the meandering accuracy maintenance region 75, tension is applied to the transported print medium S. This tension prevents the print medium S from wrinkling or sagging. The print medium S is transported to the platen 54 via the meandering accuracy maintenance region 75. A configuration including the transport rollers 313 to 321 and the vertical plate 71 disposed in the meandering accuracy maintenance region 75 is referred to as the transport roller section 4.

The transport rollers 316 to 321 disposed in the meandering accuracy maintenance region 75 transport the print medium S in a state where the meandering accuracy corrected by the meandering correction section 70 is maintained.

The supply nip motor M3, transport roller 318, and transport roller 319 configurated a transport nip section for transporting the print medium S. The control section 100 controls the speed of the supply nip motor M3. The rotation of the supply nip motor M3 is transmitted to the transport roller 318. For example, the control section 100 controls the rotation speed of the supply nip motor M3 so that the transport amount of the print medium S transported to the printing section 5 becomes constant. By controlling the speed of the supply nip motor M3, the rotational speed of transport roller 318 is controlled.

In the transport path 10, the drying section 7 is disposed downstream of the printing section 5. The drying section 7 dries the ink ejected by the printing section 5 onto the print medium S. The transport rollers 322, 323, 324, and 325 are disposed in the drying section 7. The transport roller 323 is provided between the platen 54 and the drying section 7, and applies a driving force to the print medium S when transporting the print medium S. The transport roller 323 corresponds to an example of the first driving roller. The drying section 7 includes a heater that heats at least one of the print surface and the back surface of the print surface of the print medium S, and dries the ink ejected by the printing section 5.

A tension roller 326 is provided downstream of the drying section 7. The tension roller 326 detects tension of the print medium S in the printing section 5. In addition, an after drying discharge nip section 350 is disposed at a stage after the transport roller 330 in the transport path 10. The after drying discharge nip section 350 includes the transport rollers 351, 352, and 353, and a transport nip motor M9 that drives the transport roller 352. The transport roller 352 applies a driving force to the print medium S when the print medium S is transported downstream of the drying section 7 in the transport direction T of the print medium S. The transport roller 352 corresponds to an example of the second driving roller.

The control section 100 controls the torque of the transport nip motor M9 based on the tension of the print medium S detected by the tension roller 326, and controls the transport roller 352. The control section 100 controls the torque of the transport nip motor M9 so that the tension of the print medium S detected by the tension roller 326 becomes a predetermined tension.

In the transport path 10, the transport rollers 327, 328, 329, and 330 are disposed downstream of the drying section 7.

The print medium S is transported to the winding side buffer section 61 by the transport rollers 327 to 330.

### 2. Configuration of Feed-Out Side Buffer Section

The feed-out side buffer section 60 includes a feed-out side fixed plate 65 fixed directly or indirectly to the frame of the printing device 1, and a feed-out side movable plate 67 that can move up and down. The seven transport rollers 303, 304, 305, 306, 307, 309, and 311 are rotatably supported on the feed-out side fixed plate 65. Two transport rollers 308 and 310 are rotatably supported on the feed-out side movable plate 67.

In the feed-out side buffer section 60, the print medium S winds around the transport rollers 303 to 311. The transport rollers 303, 304, 305, 306, 307, 309, and 311 are supported by the feed-out side fixed plate 65 so as not to move in the transport path 10. On the other hand, the transport rollers 308 and 310 are vertically movable together with the feed-out side movable plate 67. The transport rollers 308 and 310 and the feed-out side movable plate 67 are suspended from the feed-out side fixed plate 65 by the print medium S.

The feed-out side buffer section 60 applies a tension in the direction of gravity to the print medium S by the weight of the feed-out side movable plate 67 and the transport rollers 308 and 310 attached to the feed-out side movable plate 67.

When sag is generated in the print medium S between the medium supply section 3 and the platen 54, the sag of the print medium S is absorbed by the feed-out side movable plate 67 being lowered by an amount corresponding to the sag of the print medium S. In a case where strong tension is applied to the print medium S in the transport direction T between the medium supply section 3 and the platen 54, the print medium S is fed from the feed-out side buffer section 60 by the feed-out side movable plate 67 being raised by the tension. As described above, the feed-out side buffer section 60 absorbs or reduces the surplus of the print medium S between the medium supply section 3 and the platen 54, and the excessive or insufficient tension on the print medium S.

### 3. Configuration of the Winding Side Buffer Section

The winding side buffer section 61 includes a winding side fixed plate 68 that is directly or indirectly fixed to the frame of the printing device 1, and a winding side movable plate 69 that can move up and down. Transport rollers 336 and 338 are rotatably supported by the winding side fixed plate 68. A transport roller 337 is rotatably supported on the winding side movable plate 69.

In the winding side buffer section 61, the print medium S winds around the transport rollers 336, 337, and 338. The transport rollers 336 and 338 are supported by the winding side fixed plate 68 so as not to move in the transport path 10. On the other hand, the transport roller 337 is vertically movable together with the winding side movable plate 69. The transport roller 337 and the winding side movable plate 69 are suspended from the winding side fixed plate 68 by the print medium S.

The winding side buffer section 61 applies tension in the direction of gravity to the print medium S by the weight of the winding side movable plate 69 and the transport roller 337 attached to the winding side movable plate 69.

When sag is generated in the print medium S between the platen 54 and the medium collection section 8, the sag of the print medium S is absorbed by the winding side movable plate 69 being lowered by the amount corresponding to the sag of the print medium S. In a case where strong tension is applied to the print medium S in the transport direction T between the platen 54 and the medium collection section 8, the print medium S is fed from the winding side buffer section 61 by the winding side movable plate 69 being raised by the tension. In this manner, the winding side buffer section 61 absorbs or reduces the surplus of the print medium S between the platen 54 and the medium collection section 8, and the excessive or insufficient tension of the print medium S.

### 4. Configuration of Drying Section

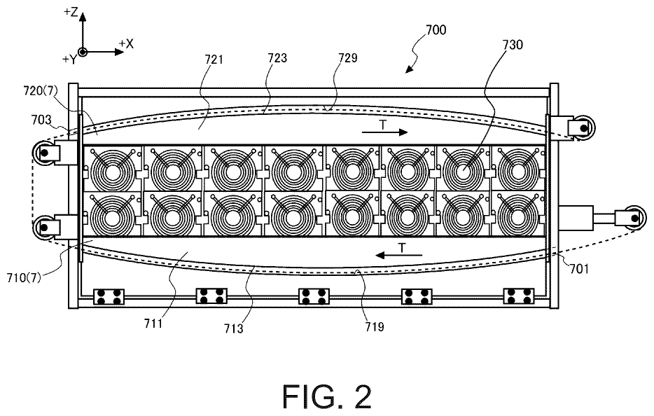

FIG. 2 is a diagram showing the configuration of drying section 7.

The drying section 7 includes a first drying section 710 and a second drying section 720.

The first drying section 710 is provided inside the housing 700. The first drying section 710 dries the post-printing print medium S that was transported from a supply port 701.

The second drying section 720 is provided inside the housing 700. The second drying section 720 dries the post-printing print medium S that was transported from a second communication port 703.

The first drying section 710 is positioned upstream of the second drying section 720 in the transport direction T. The first drying section 710 and the second drying section 720 have different transport directions T. In the first drying section 710, the direction toward the −X direction becomes the transport direction T, and in the second drying section 720, the direction toward the +X direction becomes the transport direction T.

The first drying section 710 includes a first contact heating section 711. The first contact heating section 711 is provided inside the housing 700. The first contact heating section 711 is provided at a position facing the back surface of the post-printing print medium S. The back surface of print medium S is the side opposite the print surface of print medium S on which the image was printed. The first contact heating section 711 dries the post-printing print medium S by contacting the back surface of the post-printing print medium S.

The first contact heating section 711 includes a first contact heating surface 713. The first contact heating surface 713 is a surface that faces the back surface of the post-printing print medium S in the first contact heating section 711. The first contact heating surface 713 is configured to contact the back surface of the post-printing print medium S. The first contact heating surface 713 is positioned to face the second contact heating surface 723 (to be described later) in an opposite direction.

The first contact heating surface 713 is curved to form a protruding shape toward the downward-Z direction of the vertical direction Z. The first contact heating surface 713 may be a surface formed of a metal plate material, and for example, it may be a surface formed of an aluminum plate material. In particular, the first contact heating surface 713 may be configured to curve along a support member (not shown). The first contact heating surface 713 may adopt a radius of curvature that enhances the degree of adhesion to the post-printing print medium S, while preventing the enlargement of the drying section 7 in the Z direction.

The first contact heating section 711 includes a first heater 715. The first heater 715 may be a rubber heater provided on the back surface of the first contact heating surface 713. By this, he first contact heating section 711 dries the post-printing print medium S that is in contact with the first contact heating surface 713.

The first drying section 710 includes a first airflow ejection section 719. The first airflow ejection section 719 is disposed at a position facing the first contact heating surface 713 of the first contact heating section 711, and heats the print surface of the print medium S. A plurality of airflow ejection ports are disposed in the first airflow ejection section 719. The illustration of the airflow ejection ports is omitted. By this, the first airflow ejection section 719 dries the post-printing print medium S that is in contact with the first contact heating surface 713.

The second drying section 720 includes a second contact heating section 721. The second contact heating section 721 is provided inside the housing 700. The second contact heating section 721 is provided at a position facing the back surface of the post-printing print medium S. The second contact heating section 721 dries the post-printing print medium S by contacting the back surface of the print medium S.

The second contact heating section 721 includes a second contact heating surface 723. The second contact heating surface 723 is a surface facing the back surface of the post-printing print medium S in the second contact heating section 721. The second contact heating surface 723 is configured to come into contact with the back surface of the post-printing print medium S. The second contact heating surface 723 is positioned to face away from the first contact heating surface 713.

The second contact heating surface 723 is curved to form a protruding shape toward the upward +Z direction of the vertical direction Z. The second contact heating surface 723 may be a surface formed of a metal plate material, and for example, it may be a surface formed of an aluminum plate material. In particular, the second contact heating surface 723 may be configured to curve along a support member (not shown). The second contact heating surface 723 may adopt a radius of curvature that enhances the degree of adhesion to the post-printing print medium S, while preventing the enlargement of the drying section 7 in the vertical direction Z.

The second contact heating section 721 includes a second heater 725. The second heater 725 may be a rubber heater provided on the back surface of the second contact heating surface 723. By this, the second contact heating section 721 dries the post-printing print medium S that is in contact with the second contact heating surface 723.

The second drying section 720 includes a second airflow ejection section 729.

The second airflow ejection section 729 is disposed at a position facing the second contact heating surface 723 of the second contact heating section 721, and heats the print surface of the print medium S. The second airflow ejection section 729 is provided with a plurality of airflow ejection ports. The illustration of the airflow ejection ports is omitted. By this, the second airflow ejection section 729 dries the post-printing print medium S that is in contact with the second contact heating surface 723.

### 5. Configuration of the Rear Side of the Drying Section

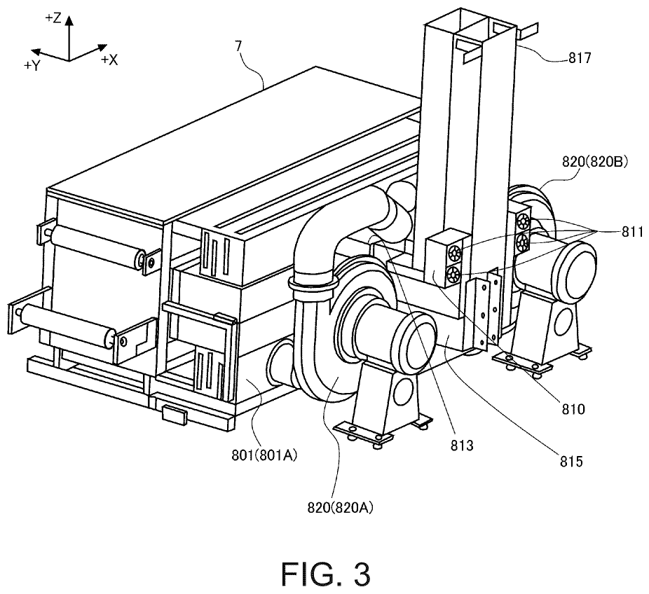

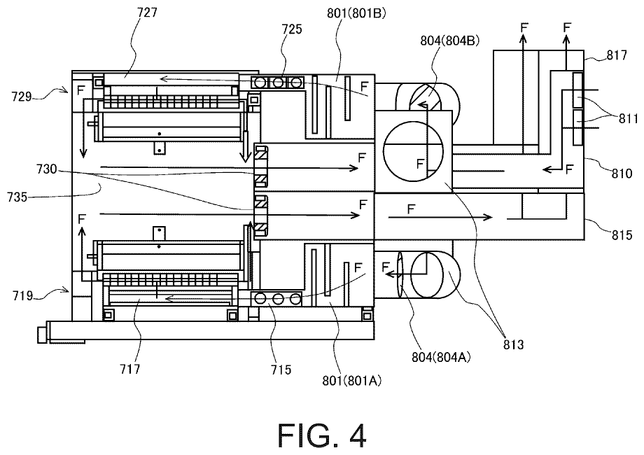

FIG. 3 is a perspective view of the periphery of the drying section of the printing device 1 as viewed from the rear side, and FIG. 4 is a cross-sectional view of the periphery of the drying section 7 of the printing device 1 as viewed from the rear side. The arrows F shown in FIG. 4 indicate the flow of the airflow.

On the rear side of the drying section 7 are provided an intake section 810, a circulation mixing section 813, a pressure chamber 801, a first airflow ejection section 719, a second airflow ejection section 729, a fan forming section 735, an exhaust passage 815, an exhaust duct 817, and a blower 820.

The intake section 810 includes an intake fan 811, and draws in outside air by the intake fan 811.

The circulation mixing section 813 includes a first valve 804A and a second valve 804B as valves 804, and the airflow F sucked in by the intake fan 811 of the intake section 810 flows into the circulation mixing section 813. The circulation mixing section 813 mixes the airflow F sucked in by the intake fan 811 with the heated airflow F. The heated airflow F will be described later.

The circulation mixing section 813 is connected to the first pressure chamber 801A and the second pressure chamber 801B, which are the two pressure chambers 801. The airflow F mixed in the circulation mixing section 813 flows into the first pressure chamber 801A and the second pressure chamber 801B.

The first pressure chamber 801A and the second pressure chamber 801B are units for uniformly applying the airflow F to a first nozzle box 717 and a second nozzle box 727. The first pressure chamber 801A is connected to the first airflow ejection section 719, and the second pressure chamber 801B is connected to the second airflow ejection section 729.

The first airflow ejection section 719 includes the first nozzle box 717. The airflow F flowing into the first airflow ejection section 719 flows into the first nozzle box 717. On the other hand, the second airflow ejection section 729 includes the second nozzle box 727. The airflow F flowing into the second airflow ejection section 729 flows into the second nozzle box 727. The first nozzle box 717 and the second nozzle box 727 are units for spraying the heated airflow F onto the print medium S.

The first nozzle box 717 faces the first contact heating surface 713 and outputs the heated airflow F to the fan forming section 735 provided with the fan 730. The second nozzle box 727 faces the second contact heating surface 723 and outputs the heated airflow F to the fan forming section 735 provided with the fan 730. The fan 730 is a DC fan and discharges the heated airflow F from the drying section 7.

The fan forming section 735 is connected to the exhaust passage 815, which is connected to the exhaust duct 817, and the airflow F is sent from the fan forming section 735 to the exhaust duct 817 via the exhaust passage 815. That is, the airflow F circulated in the drying section 7 is discharged from the exhaust duct 817 to the outside of the printing device 1.

The fan forming section 735 is also connected to the circulation mixing section 813 via the exhaust passage 815, and collects the heated airflow F and mixes it with the outside air. A first blower 820A as the blower 820 sends the airflow F mixed with the outside air and heated to the first pressure chamber 801A. A second blower 820B as the blower 820 sends the airflow F mixed with the outside air and heated to the second pressure chamber 801B. The first blower 820A and the second blower 820B, together with the intake fan 811 and the fan 730, facilitate the flow of the airflow F into the drying section 7. The first blower 820A and the second blower 820B correspond to an example of an airflow supply section that supplies the airflow F to the print surface of the print medium S. The first blower 820A and the second blower 820B are collectively referred to as blower 820.

### 6. Configuration of Control System

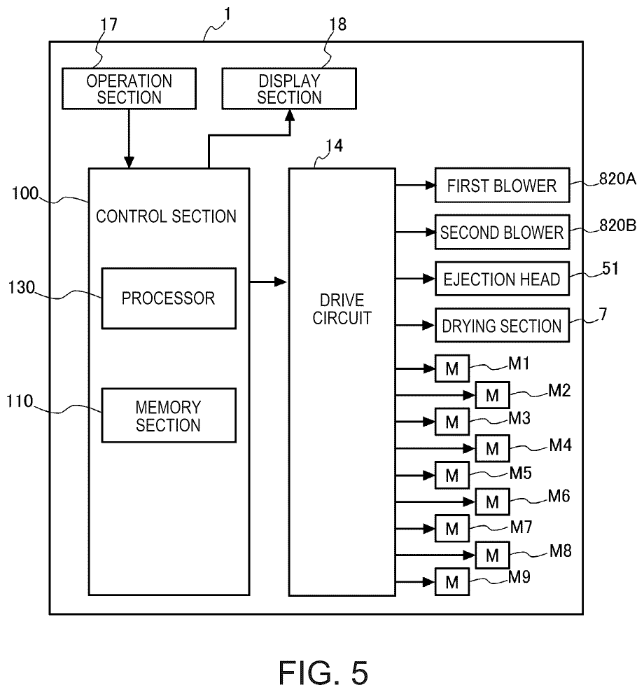

FIG. 5 is a block diagram showing a control system of the printing device 1. Next, the control system of the printing device 1 will be described with reference to FIG. 5. The printing device 1 includes an operation section 17, a display section 18, a drive circuit 14, and a control section 100.

The operation section 17 is a device in which an operator who operates the printing device 1 inputs printing conditions and the like, and is, for example, an operation panel including a switch. The operation section 17 may be an input device such as a keyboard or a mouse, or may be a tablet computer, a portable terminal, and the like that is separate from the printing device 1. The operation section 17 outputs the information input by the operator to the control section 100.

The display section 18 includes a display panel such as a liquid crystal display panel, and displays various kinds of information under the control of the control section 100. The operation section 17 and the display section 18 may be configured by a touch panel in which these sections are integrated.

The drive circuit 14 is connected to the first blower 820A, the second blower 820B, the feed-out motor M1, the feed-out nip motor M2, the supply nip motor M3, the discharge nip motor M4, the winding nip motor M5, and the winding motor M6. The drive circuit 14 is connected to the first carriage motor M7, the second carriage motor M8, and the transport nip motor M9. The drive circuit 14 drives the first blower 820A and the second blower 820B under the control of the control section 100. The drive circuit 14 transports the print medium S by driving each of the motors M1 to M6 under the control of the control section 100. The drive circuit 14 drives the first carriage motor M7 and the second carriage motor M8 according to control of control section 100, and moves the carriage 53 to reciprocate in the Y-axis direction. The drive circuit 14 drives the transport nip motor M9 according to control of the control section 100 so that the tension of the print medium S detected by the tension roller 326 becomes a predetermined tension.

The ejection head 51 and the drying section 7 are connected to the drive circuit 14. The drive circuit 14 operates the ejection head 51 to form an image on the print medium S by outputting a control signal under the control of the control section 100. The drive circuit 14 dries the print medium S by operating the heater of the drying section 7 according to the control of the control section 100.

The control section 100 is a computer device including a memory section 110 and a processor 130.

The memory section 110 includes a memory such as a Random Access Memory (RAM) or a Read Only Memory (ROM). The RAM is used for temporary storage of various types of data and the like, and the ROM stores control programs for controlling the operation of the printing device 1, various types of setting information, and the like.

The processor 130 is an arithmetic processing device configured by a Central Processing Unit (CPU) and a Micro Processing Unit (MPU). The processor 130 executes a control program to control each section of the printing device 1. The processor 130 may be configured to a single processor or may be configured to multiple processors. The processor 130 may be configured by a part or all of memory section 110 or an SoC integrated with other circuits. The processor 130 may be configured by a combination of a CPU that executes a program and a DSP arithmetic: that executes predetermined processing. Furthermore, all of the functions of processor 130 may be implemented by hardware, or may be configured using a programmable device.

The control section 100 executes a printing process. The control section 100 controls drive of the motors M1 to M6, and executes intermittent transport by repeating a transport operation for transporting the print medium S in the transport direction T by a predetermined distance and a stop operation for stopping the transport of the print medium S.

The control section 100 intermittently transports the print medium S to a predetermined area of the platen 54 and uses the printing section 5 to print an image on the print medium S transported to the predetermined area of the platen 54. When the printing process is stopped along the way, the control section 100 measures the stop time during which the printing process is stopped. For example, there is a case where an instruction to stop printing is received by the operation section 17, or a case where the printing process is stopped for a predetermined time or more due to cleaning of the ejection head 51 or the like.

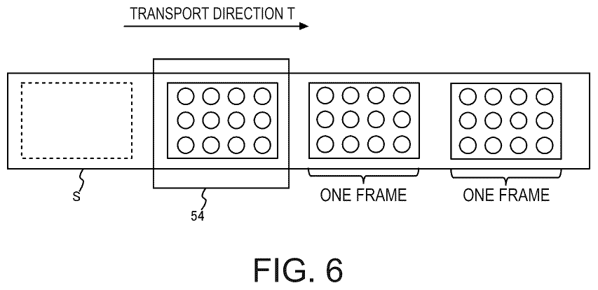

FIG. 6 is a diagram showing one frame of the print medium S. One frame refers to an image printed on print medium S by one intermittent transport. That is, the print medium S is transported to a predetermined area of the platen 54 by the transport operation included in the intermittent transport, and an image is printed on the print medium S stopped by the stop operation included in the intermittent transport. An image printed on the print medium S by one intermittent transport corresponds to one frame.

### 7. Control Operation of Control Section

In a case where the transport of the print medium S is performed after the transport of the print medium S is stopped for a predetermined time or more, the control section 100 controls the medium supply section 3 such that the print medium S is transported at the first acceleration V1. Hereinafter, an image to be printed on the print medium S first after the start of the printing operation or the resumption of the printing operation will be referred to as a first frame. After the first frame is printed on the print medium S, the print medium S is transported downstream in the transport direction T, and at this time, the control section 100 controls the medium supply section 3 so that the acceleration of the transported print medium S becomes the first acceleration V1.

In a case where the transport of the print medium S is performed before the stop time of the transport of the print medium S reaches the predetermined time, the control section 100 controls the medium supply section 3 such that the print medium S is transported at the second acceleration V2. The first acceleration V1 is an acceleration smaller than the second acceleration V2. The second acceleration V2 is an acceleration at the time of normal intermittent transport. The stop time in the intermittent transport is less than the predetermined time. Therefore, the control section 100 forms an image on the print medium S whose transportation is stopped, and transports at the second acceleration V2 the print medium S that has the image formed on it.

Situations in which the stop time during which the transport of the print medium S is stopped is equal to or longer than the predetermined time includes, for example, in a print standby and a pause in printing. Print standby refers to the state before a printing operation begins, where no print job has been received from an external device such as a personal computer. Pause in printing refers to a state in which the printing device 1 receives a print job from an external device and starts a printing operation, but temporarily stops printing on the print medium S due to a user operation, head cleaning, or the like.

When the transport of the print medium S is stopped for a predetermined time or more, the control section 100 controls the supply nip motor M3, the feed-out nip motor M2, and the discharge nip motor M4 so that the acceleration for transporting the print medium S becomes the first acceleration V1.

When the stop time of transportation of the print medium S is less than a predetermined time, the control section 100 controls the supply nip motor M3, the feed-out nip motor M2, and the discharge nip motor M4 so that the acceleration of transporting the print medium S becomes the second acceleration V2.

In a case where the transport of print medium S is stopped for a predetermined time or more, it is possible to reduce the load applied to the print medium S when transporting the print medium S and to reduce transport defects by transporting the print medium S at the first acceleration V1, which is smaller than the second acceleration V2, which is the acceleration of the transport during intermittent transport.

When the control section 100 prints the image of the first frame on the print medium S, transports the print medium S at the first acceleration V1, and then transports the print medium S on which the images of the second and subsequent frames are printed, the control section 100 controls the medium supply section 3 so that the acceleration of the print medium S becomes the second acceleration V2. Since transport of the print medium S is executed after printing the image of the first frame, sticking of the print medium S in the drying section 7 is resolved. For this reason, in a case where the print medium S is transported after the images of the second and subsequent frames are printed on the print medium S, the medium supply section 3 is controlled such that the acceleration for transporting the print medium S becomes the second acceleration V2.

The control section 100 reduces the post-platen tension during print standby and during a pause in printing to be lower than the post-platen tension during a printing operation. Similarly, the control section 100 reduces post-drying tension during a print standby and during a pause in printing to be lower than post-drying tension during a printing operation.

The post-platen tension is the tension applied to the print medium S after passing by the platen 54. The post-platen tension is the tension applied to the print medium S positioned between the platen 54 and the drying section 7.

By controlling rotation of the transport roller 323, the control section 100 reduces the post-platen tension applied to the print medium S during print standby and a pause in printing, compared to the post-platen tension applied to print medium S during a printing operation. The post-platen tension applied to the print medium S during a printing operation is referred to as the first post-platen tension. The post-platen tension applied to the print medium S during print standby and a pause in printing is referred to as a second post-platen tension.

The post-drying tension is the tension applied to the print medium S that has passed through the drying section 7. The post-drying tension is the tension applied to the print medium S positioned between the drying section 7 and the transport roller 352.

The control section 100 controls the transport roller 352 by controlling the torque of the transport nip motor M9, and reduces the post-drying tension applied to the print medium S during a print standby and during a pause in printing to be less than the post-drying tension applied to the print medium S during a printing operation. The post-drying tension applied to print medium S during a printing operation is referred to as the first post-drying tension. The post-drying tension applied to the print medium S during a print standby and during a pause in printing is referred to as the second post-drying tension.

It is possible to reduce sticking of the print medium S to the first contact heating surface 713 and to the second contact heating surface 723 by making the post-platen tension and the post-drying tension during print standby and during a pause in printing to be lower than the post-platen tension and the post-drying tension during a printing operation.

The control section 100 controls the air volume of the blower 820 so that the air volume of the blower 820 when in print standby and when in a pause in printing is smaller than the air volume of the blower 820 during a printing operation. Specifically, the control section 100 controls the inverter included in the drive circuit 14 to make the drive frequency for driving the motor included in the blower 820 to be lower than the drive frequency during a printing operation. By this, it is possible to reduce sticking of the print medium S to the first contact heating surface 713 and to the second contact heating surface 723. The drive frequency of the blower 820 during printing operations is referred to as a first drive frequency, and the drive frequency of the blower 820 when in print standby and when in a pause in printing is referred to as a second drive frequency.

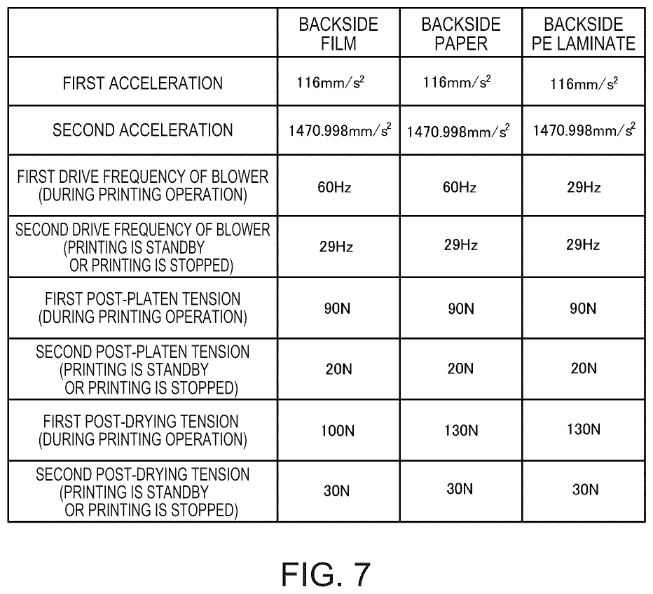

FIG. 7 is a diagram showing respective control items in a case where the print medium S is a label paper having a strip-shaped release paper and a plurality of labels, and the release paper of the label paper is a film, a case where the release paper is paper, and a case where the release paper is laminated with polyethylene. The case where the release paper of the label paper is a film is referred to as a backside film, the case where the release paper of the label paper is paper is referred to as a backside paper, and the case where the release paper of the label paper is laminated with polyethylene is referred to as a backside PE laminate. The control items controlled by the control section 100 include the first acceleration V1 and the second acceleration V2, the first drive frequency and the second drive frequency, the first post-platen tension and the second post-platen tension, and the first post-drying tension and the second post-drying tension.

The first acceleration V1 is 116 [mm/s²] in any case, whether the release paper is a film, paper, or a polyethylene laminate. The second acceleration V2 is 1470.998 [mm/s²] in the case of the release paper is a film, paper, or a polyethylene laminate.

The first drive frequency, which is the drive frequency of blower 820 during a printing operation, is 60 Hz when the release paper is a film and when the release paper is paper, and is 29 Hz when the release paper is a polyethylene laminate. During a printing operation, the drive frequency of the blower 820 is referred to as H1.

The second drive frequency, which is the drive frequency of the blower 820 when print standby or a pause in printing, is 29 [Hz] in any case whether the release paper is a film, the release paper is paper, or the release paper is a polyethylene laminate. The drive frequency of the blower 820 when print standby or pause in printing is referred to as H2.

The first post-platen tension, which is the post-platen tension during a printing operation, is 90 [N] in any case whether the release paper is a film, paper, or a polyethylene laminate. The post-platen tension during a printing operation is referred to as Tp1.

The second post-platen tension, which is the post-platen tension when printing is stopped or during a pause in printing, is 20 [N] in any case whether the release paper is a film, the release paper is paper, or the release paper is a polyethylene laminate. The post-platen tension when printing is stopped or during a pause in printing is referred to as Tp2.

The first post-drying tension, which is the post-drying tension during a printing operation, is 100 [N] when the release paper is a film, and 130 [N] when the release paper is paper or a polyethylene laminate. The post-drying tension during a printing operation is referred to as Td1.

The second post-drying tension, which is the post-drying tension when printing is stopped or during a pause in printing, is 30 [N] in any case whether the release paper is a film, the release paper is paper, or the release paper is a polyethylene laminate. The post-drying tension when printing is stopped or during pause in printing is referred to as Td2.

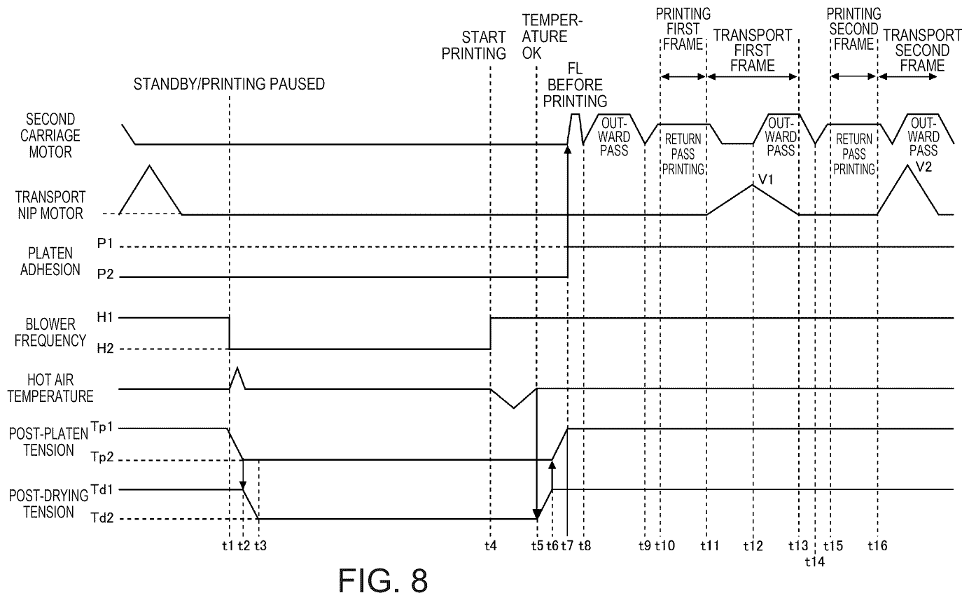

FIG. 8 is a timing chart showing the operation of the printing device 1. The operation of the printing device 1 will be described with reference to the timing chart shown in FIG. 8.

It is assumed that the printing operation of the printing device 1 is temporarily stopped at time t1 shown in FIG. 8. For example, when the control section 100 receives a user operation, the control section 100 causes the printing section 5 to stop the printing operation. When the printing operation of printing section 5 is stopped, the control section 100 controls the inverter provided in the drive circuit 14 to reduce the drive frequency for driving the motor of the blower 820 to be lower than the drive frequency during printing, thereby reducing the air volume of blower 820.

Next, when the air volume of the blower 820 is reduced, the control section 100 reduces the post-platen tension from Tp1 to Tp2 at time t2. The control section 100 controls the rotation of the transport roller 323 to reduce the tension applied to the print medium S to be lower than that during a printing operation.

Next, when the control section 100 reduces the post-platen tension, the control section 100 reduces the post-drying tension at time t3. When the control section 100 reduces the post-platen tension to Tp2, the control section 100 controls the torque of the transport nip motor M9 to control the rotation of the transport roller 352, reduces the post-drying tension from Td1 to Td2, and waits until printing is resumed.

At time t4, it is assumed that the control section 100 has received an instruction to start or resume printing. Upon receipt of an instruction to start or resume printing, the control section 100 increases the drive frequency for driving the motor of the blower 820 at time t4. The control section 100 changes the drive frequency from H2 to H1 to increase the air volume. When the air volume is increased, the temperature of the hot air output from the blower 820 is temporarily lowered, but the control section 100 controls the temperature of the hot air output from the blower 820 by PID control so that the hot air output from the blower 820 has a predetermined temperature.

For example, at time t5, it is assumed that the temperature of the hot air output from the blower 820 reaches a predetermined temperature.

When the temperature of the hot air output from the blower 820 reaches a predetermined temperature, the control section 100 increases the post-drying tension at time t5. The control section 100 controls the rotation of the transport roller 352 by controlling the torque of the transport nip motor M9, and increases the post-drying tension from Td2 to Td1. When the post-drying tension increases to Td1, the control section 100 increases the post-platen tension at time t6. The control section 100 controls the rotation of the transport roller 323 to increase the tension applied to the print medium S from Tp2 to Tp1.

When the post-platen tension increases to Tp1 at time t7, the control section 100 starts flushing. Flushing refers to a maintenance operation of ejecting ink droplets unrelated to recording from the nozzles of the ejection head by driving an actuator (not shown) for the purpose of preventing or eliminating clogging of the nozzles.

When the flushing is completed at time t8, the control section 100 moves the carriage 53 in the main scanning direction to move the printing section 5 to the start printing position. At this time, the direction of the main scanning direction in which the carriage 53 is moved is referred to as a first direction. The control section 100 reciprocates the carriage 53 in the main scanning direction. Printing on the print medium S is not performed in the outward pass in which the carriage 53 is moved, and printing on the print medium S is performed in the return pass in which the carriage 53 is moved. The direction of the main scanning direction in which carriage 53 is moved in the return pass is referred to as the second direction.

When the control section 100 moves the carriage 53 to the start printing position at time t9, the control section 100 causes the printing section 5 to execute printing in the return pass of the reciprocating movement. At time t10, printing section 5 prints the first frame on print medium S.

Next, at time t11 when the printing of the first frame on the print medium S by the printing section 5 is completed, the control section 100 starts transporting the print medium S and transports the print medium S downstream in the transport direction T. At this time, the control section 100 controls the supply nip motor M3, the feed-out nip motor M2, and the discharge nip motor M4 so that the acceleration for transporting the print medium S becomes the first acceleration V1. As shown in FIG. 8, the control section 100 accelerates the transport speed of the print medium S at a first acceleration V1 when increasing the transport speed of the print medium S, and decelerates the transport speed of the print medium S at a decelerating speed with the same value as the first acceleration V1 when decreasing and stopping the transport speed of the print medium S.

The control section 100 moves the carriage 53 in the first direction to the start printing position at time t12 while moving the print medium S downstream in the transport direction T. When the movement of the print medium S is completed at time t13 and the movement of the carriage 53 in the first direction is completed at time t14, the control section 100 moves the carriage 53 in the second direction and prints the second frame on the print medium S at time t15.

When the printing of the second frame on the print medium S is completed at time t16, the control section 100 starts the transport of the print medium S and transports the print medium S downstream in the transport direction T. At this time, the control section 100 controls the supply nip motor M3, the feed-out nip motor M2, and the discharge nip motor M4 so that the acceleration for transporting the print medium S becomes the second acceleration V2. The second acceleration V2 is an acceleration with a value greater than that of the first acceleration V1. At this time, as shown in FIG. 8, the control section 100 accelerates the transport speed of the print medium S at the second acceleration V2 when increasing the transport speed of the print medium S, and decelerates the transport speed of the print medium S at a same value of the decelerating speed as the second acceleration V2 when decreasing and stopping the transport speed of the print medium S.

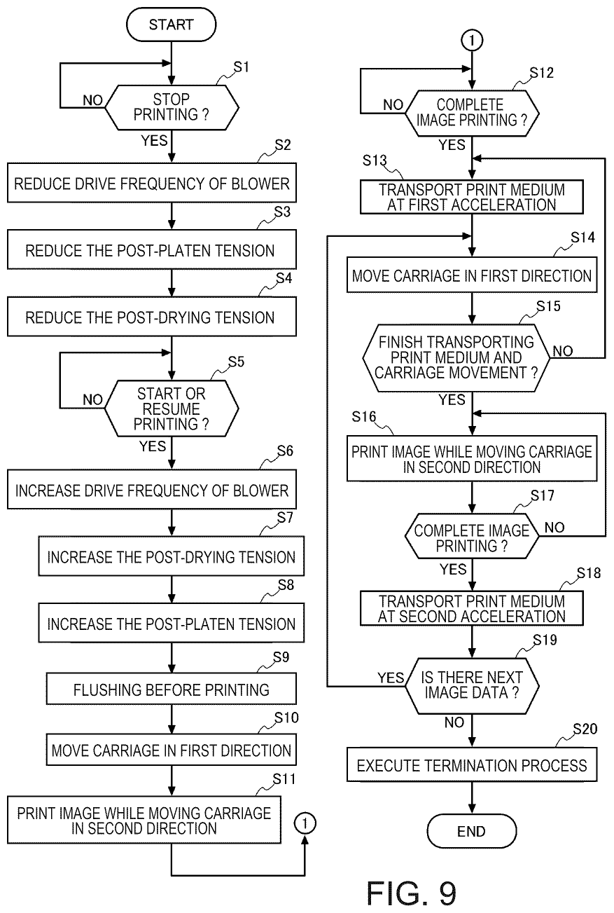

FIG. 9 is a flowchart showing the operation of the control section 100. The operation of the control section 100 will be described with reference to the flowchart shown in FIG. 9.

First, the control section 100 determines whether a situation has occurred in which the printing operation is stopped (step S1). The situations in which the printing operation is stopped includes, for example, a case where a printing job is executed and the printing operation is concluded, and a case where printing on the print medium S is temporarily paused by a user operation, a head cleaning, or the like.

If a situation in which the printing operation is stopped has not occurred (step S1:NO), the control section 100 determines again whether or not a situation in which a printing operation is stopped has occurred.

When a situation occurs in which a printing operation is stopped (step S1:YES), the control section 100 reduces the drive frequencies of the blower 820 from H1 to H2 (step S2).

Next, the control section 100 controls rotation of the transport roller 323 to reduce the post-platen tension from Tp1 to Tp2 (step S3).

Further, the control section 100 controls the torque of the transport nip motor M9 to reduce the post-drying tension from Td1 to Td2 (step S4).

Next, the control section 100 determines whether to start or to resume the printing operation (step S5). The control section 100 determines to start or to resume the printing operation when a print job is received from an external device, an instruction to resume printing is given by a user operation, a head cleaning is completed, or the like.

If the control section 100 does not start or resume the printing operation (step S5:NO), the control section 100 waits until the printing operation is started or resumed. When starting or resuming the printing operation (step S5:YES), the control section 100 increases the drive frequency of the blower 820 from H2 to H1 (step S6). Thereafter, when the hot air temperature increases to a predetermined value or more, the control section 100 controls the torque of the transport nip motor M9 to increase the post-drying tension from Td2 to Td1 (step S7). Further, the control section 100 controls rotation of the transport roller 323 to increase the post-platen tension from Tp2 to Tp1 (step S8).

Next, control section 100 causes printing section 5 to execute flushing before printing (step S9). Thereafter, the control section 100 moves the carriage 53 in the first direction of the main scanning direction (step S10), and moves the carriage 53 to the start printing position. Then, the control section 100 prints an image, which is a first frame, on the print medium S while moving the carriage 53 in the second direction of the main scanning direction (step S11).

Next, the control section 100 determines whether or not the printing of the first frame image on the print medium S is completed (step S12). If the printing of the image of the first frame on the print medium S is not completed (step S12:NO), the control section 100 waits until the printing of the image of the first frame is completed.

When printing of the image of the first frame on the print medium S is completed (step S12:YES), the control section 100 controls the supply nip motor M3, the feed-out nip motor M2, and the discharge nip motor M4 to transport the print medium S to the downstream side in the transport direction T. At this time, the control section 100 controls the supply nip motor M3, the feed-out motor M2, and the discharge nip motor M4 so that acceleration of the print medium S becomes the first acceleration V1 (step S13).

The control section 100 transports the print medium S to the downstream side in the transport direction T, moves the carriage 53 that has moved in the second direction in the first direction, and moves the carriage 53 to the start printing position (step S14).

Next, the control section 100 determines whether the transport of the print medium S and the movement of the carriage 53 are completed (step S15). If the transportation of the print medium S or the movement of the carriage 53 has not been completed (step S15:NO), the control section 100 waits until transportation of the print medium S and movement of the carriage 53 are completed.

When transportation of the print medium S and movement of the carriage 53 are completed (step S15:YES), the control section 100 prints the second frame on the print medium S while moving the carriage 53 in the second direction of the main scanning direction (step S16).

Next, the control section 100 determines whether or not the printing of the second frame on the print medium S is completed (step S17). If the printing of the image of the second frame on the print medium S is not completed (step S17:NO), the control section 100 waits until the printing of the image of the second frame is completed.

When the printing of the image of the second frame is finished, the control section 100 controls the supply nip motor M3, the feed-out motor M2, and the discharge nip motor M4 to transport the print medium S to the downstream side in transport direction T. At this time, the control section 100 controls the supply nip motor M3, the feed-out motor M2, and the discharge nip motor M4 so that acceleration of the print medium S becomes the second acceleration V2 (step S18).

Next, the control section 100 determines whether or not there is a next image to be printed on the print medium S (step S19). If there is a next image (step S19:YES), the control section 100 returns to step S14 and repeats the processes from step S14 onwards.

When there is no next image (step S19:NO), that is, when the image data included in the print job received from the external device has been printed in the number designated by the print job, the control section 100 executes the termination process (step S20). The termination process includes moving the carriage 53 in the first direction of the main scanning direction and moving the carriage 53 to the start printing position, and a process of reducing the drive frequency of the blower 820 from H1 to H2. The termination process includes a process of reducing the post-platen tension from Tp1 to Tp2 and a process of reducing the post-drying tension from Td1 to Td2.

### 8. First Modification

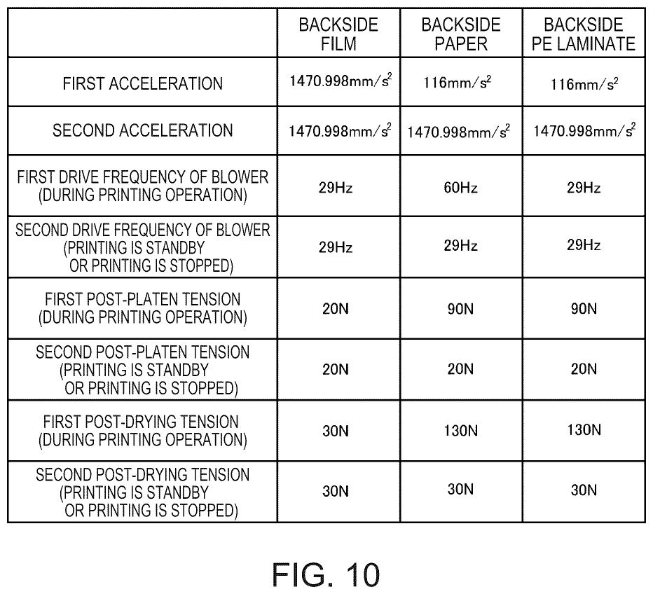

FIG. 10 is a diagram showing respective control items of a modification in a case where the release paper of the label paper is a film, the case where the release paper is a paper, and the case where the release paper is laminated with polyethylene. The control items are the same as those in the embodiment shown in FIG. 9.

In this modification, when the back surface of the print medium S is made of a material that does not stick to the first contact heating surface 713 and the second contact heating surface 723, the medium supply section 3 is controlled so that the acceleration at the time of transporting the print medium S on which the image of the first frame is printed becomes the second acceleration V2. That is, even in a case where the print medium S on which the image of the first frame is printed is being transported, the print medium S is transported at the second acceleration V2, which is the acceleration during intermittent transport. An example of a material that prevents the back surface of the print medium S from sticking to the contact heating surface is a film. The user operates the operation section 17 to input the type of the print medium S. The control section 100 changes the acceleration when the print medium S is transported, based on the type of the print medium S received by the operation section 17.

As shown in FIG. 10, when the material of the back surface of the print medium S is a film, the control section 100 controls the feed nip motor M3, the feed-out nip motor M2, and the discharge nip motor M4 so that the first acceleration V1 and the second acceleration V2 have the same value of 1470.998 [mm/s²].

In a case where the material of the back surface of the print medium S is a film, the control section 100 controls the blower 820 such that the first drive frequency and the second drive frequency have the same value of 29 [Hz].

In a case where the material of the back surface of the print medium S is a film, the control section 100 controls the rotation of the transport roller 323 such that the first post-platen tension and the second post-platen tension have the same value of 20 [N].

In case where the material on the back surface of the print medium S is a film, the control section 100 controls the torque of the transport nip motor M9 so that the first post-drying tension and the second post-drying tension are equal, at a value of 30 [N].

### 9. Second Modification

In the above-described embodiment, the control section 100 performs control such that the inclination of the first acceleration V1 at which the transport speed of the print medium S is increased and the inclination of the deceleration at which the transport speed of the print medium S is reduced and stopped have the same value. In the second modification, the control section 100 controls the supply nip motor M3, the feed-out nip motor M2, and the discharge nip motor M4 so that the absolute value of the inclination of the first acceleration V1 is different from the absolute value of the inclination of the deceleration. For example, the control section 100 controls the supply nip motor M3, the feed-out nip motor M2, and the discharge nip motor M4 so that the absolute value of the inclination of the deceleration is larger than the absolute value of the inclination of the first acceleration V1.

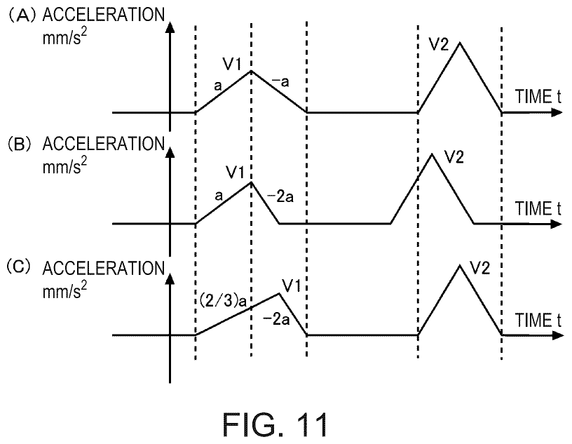

FIG. 11 is a diagram showing the first acceleration V1 and the second acceleration V2 of the second modification example. (A) in FIG. 11 shows a case where the inclination of the first acceleration V1 shown in the above-described embodiment is the same as the inclination of the deceleration. The inclination of the first acceleration V1 shown in (A) of FIG. 11 is assumed to be “a”, and the inclination of the deceleration is assumed to be “−a”.

(B) in FIG. 11 shows the case where the inclination of the first acceleration V1 is “a” which is the same as that in (A) of FIG. 11, but the inclination of the deceleration is “−2a” which is twice as large as that in (A) of FIG. 11. The deceleration with a inclination of “−2a” is referred to as the first deceleration. In the example shown in (B) of FIG. 11, the start printing timing and the transport start timing of the print medium S of the image of the second frame can be advanced by the amount of shortening of the time for completing the transport of the print medium S.

After the print medium S is transported at the acceleration of the first acceleration V1 with an inclination of “a”, the transport distance when the print medium S is decelerated and stopped at the first deceleration with an inclination of “−2a” is defined as R1. After the print medium S is transported at the second acceleration V2, which is the acceleration used for the transportation of the print medium S after the second frame, the transport distance when the print medium S is decelerated and stopped at the second deceleration having the same inclination as the second acceleration V2 is defined as R2. At this time, the inclination of the first deceleration is adjusted so that the transport distance R1 and the transport distance R2 become equal to each other.

(C) of FIG. 11 shows the case where the inclination of the first acceleration V1 is set to “⅔a” which is smaller than the case of (A) of FIG. 11, and the inclination of the deceleration is set to “−2a” which is twice as large as the case of (A) of FIG. 11. (C) of FIG. 11 shows a case where the transport start timing and the transport end timing of the print medium S of the first frame are made to coincide with the transport start timing and the transport end timing of the print medium S of the first frame shown in (A) of FIG. 11. In this case, since the inclination of the first acceleration V1 is small, the transport time of the print medium S in the first frame is not changed, but by increasing the first acceleration V1 over a longer period than the case shown in (A) of FIG. 11, it is possible to enhance the transport force and further reduce the adhesion of the print medium S to the first contact heating surface 713 and the second contact heating surface 723.

### 10. Other Embodiments

The above-described embodiment and modifications are preferred embodiments of the present disclosure. However, the present disclosure is not limited thereto, and various modifications can be made without departing from the scope of the present disclosure. For example, the process units of the flowchart shown in FIG. 9 are divided according to the main processing contents in order to facilitate understanding of the processes of the printing device 1. The present disclosure is not limited by the way of dividing the process units and the names shown in the flowchart of FIG. 9. The processes of printing device 1 may be divided into more process units according to the processing content, or may be divided such that one process unit includes more processes.

The processing order of the above-described flowchart is not limited to the illustrated example.

Each functional section of the printing device 1 shown in FIGS. 1 to 5 is a functional configuration realized by the cooperation of hardware and software, a specific implementation form is not particularly limited. Therefore, it is not always necessary to mount hardware individually corresponding to each functional section, and it is also possible to adopt a configuration in which one processor executes a program to realize the functions of a plurality of functional sections. Some of the functions implemented by software in the above-described embodiments may be implemented by hardware, or some of the functions implemented by hardware may be implemented by software.

### 11. Summary of the Present Disclosure

Hereinafter, a summary of the present disclosure is appended.

### APPENDIX 1

A printing device including a transport section configured to perform intermittent transport in which an operation of transporting a medium in a transport direction by a predetermined distance and an operation of stopping the transport of the medium are repeated, a printing section configured to eject a liquid onto the medium to perform printing while the transport of the medium is stopped during the intermittent transport of the medium, a drying section that dries the liquid ejected onto the medium by the printing section; and a control section, wherein the drying section includes a contact heating section and an airflow ejection section that is disposed at a position facing the contact heating section and ejects an airflow from an airflow ejection port, and wherein the contact heating section includes a contact heating surface which comes into contact with a back surface opposite to a print surface of the medium onto which the printing section ejects the liquid, the airflow ejection port faces the contact heating surface, the control section is configured to transport the medium at a first acceleration when the medium is transported after a stop time during which transport of the medium by the transport section is stopped is equal to or longer than a predetermined time and transport the medium at a second acceleration greater than the first acceleration when the medium is transported before the stop time exceeds the predetermined time, and the stop time of the medium in the intermittent transport is less than the predetermined time.

According to this configuration, if the transport of the medium is carried out after the stop time during which the transport of the medium by the transport section is stopped exceeds the predetermined time, the medium is transported at the first acceleration and when the medium is transported before the stop time exceeds the predetermined time, transports the medium at a second acceleration that is greater than the first acceleration. When the medium remains in the drying section for a predetermined time or more, sticking occurs between the medium and the contact heating surface, and due to this sticking, the transport load of the medium increases, and a transport failure may occur. For this reason, in a case where the stop time is equal to or longer than the predetermined time and the medium adheres to the contact heating surface, by transporting the medium at the first acceleration which is smaller than the second acceleration, the transport force of the medium is increased, and the adhesion of the medium to the contact heating surface is more easily removed. Therefore, it is possible to prevent the transport failure due to the increase of the transport load and transport the medium with high accuracy.

### APPENDIX 2

The printing device according to appendix 1, wherein the control section is configured to when the transport section is to perform intermittent transport, if a stop time in which the transport of the medium is stopped before intermittent transport is performed is equal to or longer than the predetermined time, transport the medium at the first acceleration in a first transport of the medium in the intermittent transport and transport the medium at the second acceleration in second and subsequent transports of the medium in the intermittent transport.

According to this configuration, in the first transport of the medium during intermittent transport, the medium is transported at a first acceleration, and in the second and subsequent transports of the medium in the intermittent transport, the medium is transported at a second acceleration. For this reason, in a case where sticking of the medium to the contact heating surface occurs, by transporting the medium at a first acceleration which is smaller than the second acceleration, the transport force of the medium is increased, and sticking of the medium to the contact heating surface is easily peeled off. Since sticking of the medium to the contact heating surface does not occur in the second or subsequent transport of the medium in the intermittent transport, a transport failure due to an increase in the transport load does not occur. Therefore, it is possible to efficiently transport the medium by transporting the medium at the second acceleration, which has a larger value than the first acceleration.

### APPENDIX 3

The printing device according to appendix 1 or 2, wherein the control section is configured to when the medium is transported after a stop time during which the transport of the medium by the transport section is stopped is equal to or longer than the predetermined time, start transport of the medium at the first acceleration, then decelerate the medium at a first deceleration and stop the medium and an absolute value of inclination of the first deceleration is larger than an absolute value of inclination of the first acceleration.

According to this configuration, if the medium is transported after the stop time has elapsed for the predetermined time or longer, after the transport of the medium is started at the first acceleration the medium is decelerated at the first deceleration and stopped. The absolute value of the inclination of the first deceleration is larger than the absolute value of the inclination of the first acceleration. Therefore, it is possible to shorten the time until the transport of the medium is completed, and it is possible to shorten the time until the end of printing.

### APPENDIX 4

The printing device according to appendix 3, wherein the control section is configured to when transport of the medium by the transport section is performed before a stop time of the transport of the medium by the transport section reaches the predetermined time, start transport of the medium at a second acceleration, then decelerate the medium at a second deceleration and stop transport of the medium and a transport distance of the medium when the medium is transported by decelerating the medium at the first deceleration after accelerating the medium at the first acceleration is equal to a transport distance of the medium when the medium is transported by decelerating the medium at the second deceleration after accelerating the medium at the second acceleration.

According to this configuration, in a case where the transport of the medium is performed before the stop time reaches a predetermined time, then after the medium starts to be transported at the second acceleration, the medium is decelerated at the second deceleration and is stopped. The transport distance of the medium when the medium is transported by decelerating at the first deceleration after accelerating at the first acceleration is equal to the transport distance of the medium when the medium is transported by decelerating at the second deceleration after accelerating at the second acceleration. For this reason, it is possible to adjust the transport distance between a case in which the medium is transported at the first acceleration and the medium is decelerated at the first deceleration and stopped, and a case in which the medium is transported at the second acceleration and the medium is decelerated at the second deceleration and stopped.

### APPENDIX 5

The printing device according to any one of appendices 1 to 4, further including a support section that supports the medium at a position facing the printing section with the medium interposed therebetween, a first driving roller that applies a driving force to the medium when the medium is transported between the support section and the drying section in the transport direction of the medium, and a second drive roller that applies a drive force to the medium when the medium is transported downstream of the drying section in the transport direction of the medium, wherein when the time during which the medium is not transported equals or exceeds the predetermined time, the control section controls the first drive roller such that a tension applied to the medium positioned between the support section and the drying section is smaller than a tension applied to the medium positioned between the support section and the drying section while the medium is being transported and controls the second drive roller such that a tension applied to the medium positioned between the drying section and the second drive roller is smaller than a tension applied to the medium positioned between the drying section and the second drive roller while the medium is being transported.

According to this configuration, the first driving roller is controlled such that the tension applied to the medium positioned between the support section and the drying section is smaller than the tension applied to the medium positioned between the support section and the drying section during the transport of the medium. Therefore, it is possible to reduce sticking of the medium to the contact heating surface.

### APPENDIX 6

The printing device according to any one of appendices 1 to 5, wherein the drying section includes an airflow supply section that supplies an airflow to be ejected from the airflow ejection port onto the print surface of the medium and when the time during which the medium is not being transported is equal to or longer than the predetermined time, the control section controls the airflow supply section such that the amount of airflow supplied by the airflow supply section is smaller than an amount of the air flow supplied by the air flow supply section while the medium is being transported.

According to this configuration, the airflow supply section is controlled such that the amount of airflow supplied by the airflow supply section is smaller than the amount of airflow supplied by the airflow supply section while the medium is being transported in a case where the time during which the medium is not being transported is equal to or longer than the predetermined time. For this reason, it is possible to reduce sticking of the medium to the contact heating surface which occurs during the stop time in which the transport of the medium is stopped.

### APPENDIX 7

A control method of a printing device, the printing device including a transport section that performs intermittent transport, in which an operation of transporting a medium by a predetermined distance in the transport direction and an operation of stopping the transport of the medium are repeated, a printing section configured to eject a liquid onto the medium to perform printing while the transport of the medium is stopped during the intermittent transport of the medium, and a drying section that dries the liquid that was ejected onto the medium by the printing section, wherein the drying section includes a contact heating section and an airflow ejection section that is disposed at a position facing the contact heating section and that ejects an airflow from an airflow ejection port, the contact heating section includes a contact heating surface that contacts a back surface opposite to a print surface of the medium onto which the printing section ejects the liquid, and the airflow ejection port faces the contact heating surface, the control method including transporting the medium at a first acceleration when the medium is transported after a stop time during which transport of the medium by the transport section is stopped is equal to or longer than a predetermined time and when the medium is transported before the stop time exceeds the predetermined time, transporting at a second acceleration that is greater than the first acceleration, wherein the stop time of the medium in intermittent transport is less than the predetermined time.

According to this configuration, if the transport of the medium is carried out after the stop time during which the transport of the medium by the transport section is stopped exceeds the predetermined time, the medium is transported at the first acceleration and when the medium is transported before the stop time exceeds the predetermined time, transports the medium at a second acceleration that is greater than the first acceleration. When the medium remains in the drying section for a predetermined time or more, sticking occurs between the medium and the contact heating surface, and due to this sticking, the transport load of the medium increases, and a transport failure may occur. For this reason, in a case where the stop time is equal to or longer than the predetermined time and the medium adheres to the contact heating surface, by transporting the medium at the first acceleration which is smaller than the second acceleration, the transport force of the medium is increased, and the adhesion of the medium to the contact heating surface is more easily removed. Therefore, it is possible to prevent the transport failure due to the increase of the transport load and transport the medium with high accuracy.

What is claimed is:

1. A printing device comprising:
a transport section configured to perform intermittent transport in which an operation of transporting a medium in a transport direction by a predetermined distance and an operation of stopping the transport of the medium are repeated;
a printing section configured to eject a liquid onto the medium to perform printing while the transport of the medium is stopped during the intermittent transport of the medium; a drying section configured to dry the liquid that was ejected onto the medium by the printing section; and
a control section, wherein
the drying section includes
a contact heating section and
an airflow ejection section that is disposed at a position facing the contact heating section and that is configured to eject an airflow from an airflow ejection port,
the contact heating section includes
a contact heating surface that contacts a back surface opposite from a print surface, which is the surface of the medium onto which the printing section ejects the liquid,
the airflow ejection port faces the contact heating surface,
the control section is configured to
transport the medium at a first acceleration when the medium is transported after a stop time during which transport of the medium by the transport section is stopped is equal to or longer than a predetermined time and
transport the medium at a second acceleration greater than the first acceleration when the medium is transported before the stop time exceeds the predetermined time, and
the stop time of the medium in the intermittent transport is less than the predetermined time.

2. The printing device according to claim 1, wherein
the control section is configured to
when the transport section is to perform intermittent transport, if a stop time in which the transport of the medium is stopped before intermittent transport is performed is equal to or longer than the predetermined time,
transport the medium at the first acceleration in a first transport of the medium in the intermittent transport and
transport the medium at the second acceleration in second and subsequent transports of the medium in the intermittent transport.

3. The printing device according to claim 1, wherein
the control section is configured to
when the medium is transported after a stop time during which the transport of the medium by the transport section is stopped is equal to or longer than the predetermined time,
start transport of the medium at the first acceleration, then decelerate the medium at a first deceleration and stop the medium and
an absolute value of inclination of the first deceleration is larger than an absolute value of inclination of the first acceleration.

4. The printing device according to claim 3, wherein
the control section is configured to
when transport of the medium by the transport section is performed before a stop time of the transport of the medium by the transport section reaches the predetermined time, start transport of the medium at a second acceleration, then decelerate the medium at a second deceleration and stop transport of the medium and
a transport distance of the medium when the medium is transported by decelerating the medium at the first deceleration after accelerating the medium at the first acceleration is equal to a transport distance of the medium when the medium is transported by decelerating the medium at the second deceleration after accelerating the medium at the second acceleration.

5. The printing device according to claim 1, further comprising:
a support section that supports the medium at a position facing the printing section with the medium interposed therebetween;
a first driving roller that applies a driving force to the medium when the medium is transported between the support section and the drying section in the transport direction of the medium; and
a second drive roller that applies a drive force to the medium when the medium is transported downstream of the drying section in the transport direction of the medium, wherein
when the time during which the medium is not transported equals or exceeds the predetermined time,
the control section
controls the first drive roller such that a tension applied to the medium positioned between the support section and the drying section is smaller than a tension applied to the medium positioned between the support section and the drying section while the medium is being transported and
controls the second drive roller such that a tension applied to the medium positioned between the drying section and the second drive roller is smaller than a tension applied to the medium positioned between the drying section and the second drive roller while the medium is being transported.

6. The printing device according to claim 1, wherein
the drying section includes an airflow supply section that supplies an airflow to be ejected from the airflow ejection port onto the print surface of the medium and
when the time during which the medium is not being transported is equal to or longer than the predetermined time, the control section controls the airflow supply section such that the amount of airflow supplied by the airflow supply section is smaller than an amount of the air flow supplied by the air flow supply section while the medium is being transported.

7. A control method of a printing device, the printing device including
a transport section configured to perform intermittent transport in which an operation of transporting a medium in a transport direction by a predetermined distance and an operation of stopping the transport of the medium are repeated,
a printing section configured to eject a liquid onto the medium to perform printing while the transport of the medium is stopped during the intermittent transport of the medium, and
a drying section that dries the liquid that was ejected onto the medium by the printing section, wherein
the drying section includes
a contact heating section and
an airflow ejection section that is disposed at a position facing the contact heating section and that ejects an airflow from an airflow ejection port,
the contact heating section includes a contact heating surface that contacts a back surface opposite to a print surface of the medium onto which the printing section ejects the liquid, and
the airflow ejection port faces the contact heating surface, the control method comprising:
transporting the medium at a first acceleration when the medium is transported after a stop time during which the transport of the medium by the transport section is stopped is equal to or longer than a predetermined time and
when the medium is transported before the stop time exceeds the predetermined time, transporting at a second acceleration that is greater than the first acceleration, wherein
the stop time of the medium in intermittent transport is less than the predetermined time.
